(19) United States
(12) Patent Application Publication
(10) Pub. No.: US 2005/0201581 A1
(43) Pub. Date: Sep. 15, 2005

(54) Portable speaker system

(76) Inventors: Eric David Supinski, Springfield, MA (US); Jason D'Amours, Springfield, MA (US)

Correspondence Address: William F. Lang, IV;Eckert Seamans Cherin & Mellott, LLC, 44th Floor, 600 Grant Street, Pittsburgh, PA, 15219, US

(21) Appl. No.: 11/085,329

(22) Filed: Mar. 21, 2005

Related U.S. Application Data
(63) Continuation-in-part of application No. 09/963,707, filed on Sep. 27, 2001, now abandoned.

(51) Int. Cl. H04R 1/02; H04R 5/02; H04R 9/06

(52) U.S. Cl. 381/333; 381/301; 381/388

(57) ABSTRACT

A speaker system may be mounted on the back of a user's chair, and includes flexibly positionable speakers that may be positioned relatively close to the user's ears. The speaker system thereby permits listening to audio material at a low volume, without disturbing others, without the disadvantage of headphones. The speaker system further provides for the interconnection of multiple speaker systems for use with the same audio source.

### CROSS REFERENCE TO RELATED APPLICATIONS

This application is a Continuation-In-Part of U.S. patent application Ser. No. 09/963,707, filed Sep. 27, 2001.

### BACKGROUND OF THE INVENTION

1. Field of the Invention

The present invention relates to a portable speaker system. More specifically, the invention provides a speaker system that may be removably secured to a supporting object, and provides for flexible positioning of the speakers.

2. Description of the Related Art

Many speakers are presently available. Such speakers include large speakers intended to be used in a fixed location, smaller, portable speakers, and headphones.

Headphones or portable speakers are often utilized when a portable speaker system is needed. Headphones have the disadvantage of blocking out sound except that delivered through the headphones. Speakers require the use of higher volume levels for comfortable listening, resulting in possible annoyance to others who are nearby. Many portable speaker systems provide little flexibility as to how and where they are positioned during use.

Accordingly, there is a need for a portable speaker system providing enhanced flexibility in the positioning and securing of the speakers and which permits the speakers to be positioned close to a listener's ears to permit the listener to utilize sufficiently low volume levels so that others are not subjected to unwanted noise. There is a further need for a speaker system that permits interconnecting additional speaker systems.

### SUMMARY OF THE INVENTION

The present invention is a portable speaker system structured to be removably secured to a fixed object such as a chair, and to provide flexible positioning of the speakers.

For the purpose of this description, “flexibly positionable” means capable of being moved into a desired position by merely grabbing the flexibly positionable object, and moving the object to a desired location, after which the object will remain substantially in the desired location until moved again.

The speaker system includes a main housing having a pair of flexibly positionable speakers secured thereto. In some preferred embodiments, the speakers are connected to the main housing by flexible tubing containing the necessary electrical wiring therein. The housing includes means for securing the housing to a fixed object, which in some preferred embodiments may include one or more extendible hangers structured to fit over the back of a chair. Alternatively, flexible straps may be provided for securing the housing to a fixed object.

The housing further includes appropriate electrical connections to connect the wiring within the housing to an audio source such as a stereo, radio, DVD player, cassette player, or similar device. A second connector may be provided for transmitting signals from the wiring within the housing to the wiring within the housing of a second portable speaker system. Multiple portable speaker systems may thereby be interconnected.

Accordingly, it is an object of the present invention to provide a portable speaker system suitable for use with a wide variety of audio sources.

It is another object of the invention to provide a portable speaker system providing for flexible positioning of the speakers.

It is a further object of the invention to provide a portable speaker system that may be removably secured to a variety of fixed objects such as chairs.

It is another object of the invention to provide a portable speaker system that may be interconnected with other portable speaker systems, so that multiple speaker systems may be used with a single audio source.

It is a further object of the invention to provide a portable speaker system permitting the speakers to be positioned close to a listener's ears, thereby permitting the use of sufficiently low volume levels to resist exposing others to unwanted noise.

It is another object of the invention to provide a portable speaker system permitting the safe use of sufficient volume to permit others to listen to sound produced by the speakers when desired.

These and other objects of the invention will become more apparent through the following description and drawings.

### BRIEF DESCRIPTION OF THE DRAWINGS

FIG. 1 is a front view of a portable speaker system according to the present invention.

FIG. 2 is a back view of a portable speaker system according to the present invention.

FIG. 3 is a front perspective view of a speaker system according to the present invention.

FIG. 4 is a side view of a portable speaker system according to the present invention.

FIG. 5 is a schematic view of the wiring within the main housing of a speaker system according to the present invention.

FIG. 6 is a schematic view of the wiring within each speaker.

Like reference numbers denote like elements throughout the drawings.

### DETAILED DESCRIPTION

The present invention provides a portable speaker system providing the ability to be removably secured to another object, and to provide flexible positioning of the speakers.

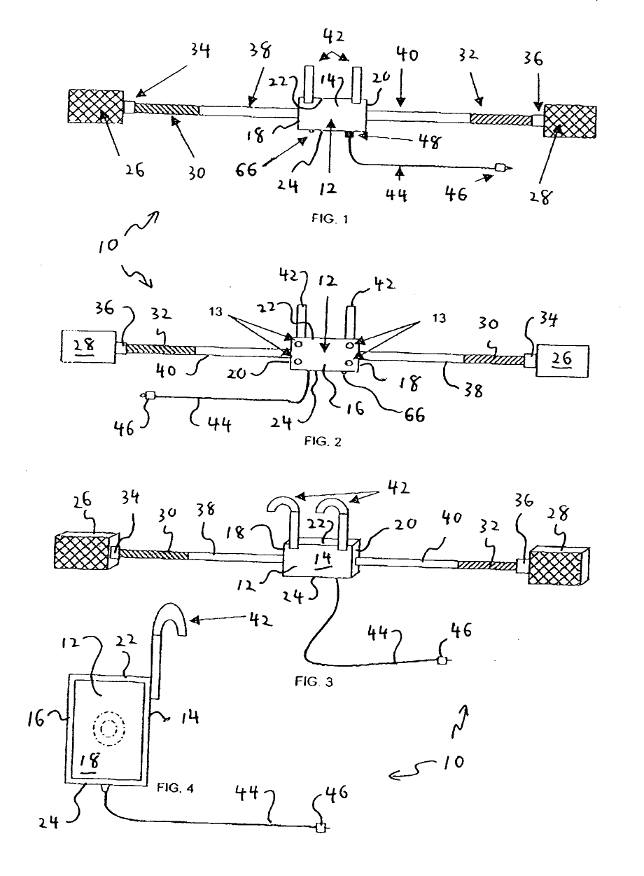

Referring to FIGS. 1-4, the speaker system 10 includes a main housing 12 having a front 14, back 16, pair of sides 18, 20, top 22, and bottom 24. The system further includes a pair of speakers 26, 28 are connected to the main housing 12. In the illustrated embodiment, flexible tubing 30, 32, which may be made from metal or other suitable materials known in the art, extends from each of the speakers 26, 28, respectively through the connectors 34, 36. The opposite end of the flexible tubing 30, 32 is connected to compression stem connectors 38, 40, which are in turn connected to holes defined within the sides 18, 20 within the main housing 12. The main housing 12 further includes means for removably securing the main housing 12 to an object, which in the illustrated example, includes the extendable hooks 42, which extend upward from the front 14, and are dimensioned and configured to fit over the top of a chair.

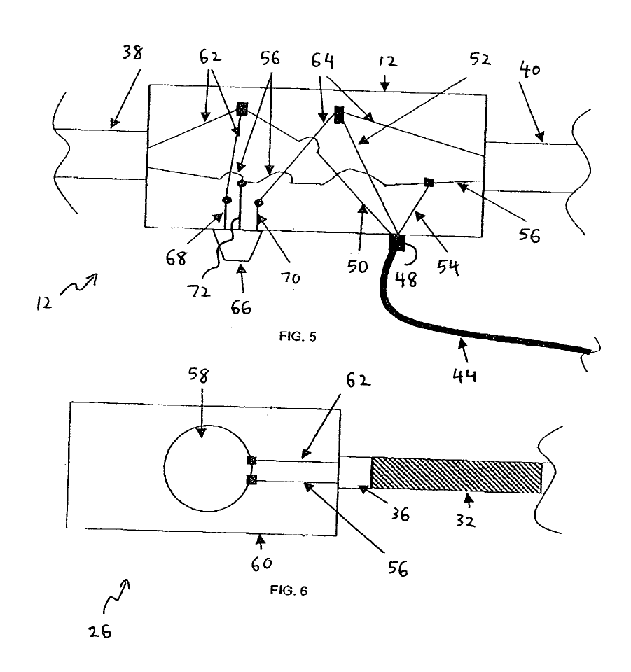

Referring to FIGS. 5-6, the wiring of the speaker system 10 is illustrated. Although only the speaker 26 is illustrated in FIG. 6, the speaker 28 is identical. Electrical connection to an audio source such as a stereo system is provided by the cord 44, which is preferably a three wire cord having a male connector 46 at its free end. In the illustrated embodiment, the cord 44 passes into the main housing 12 through a hole defined within the bottom 24, and is secured in place with a rubber bushing 48. The cord 44 contains a pair of positive wires 50, 52 and a negative wire 54 therein. The negative wire 54 is electrically connected to the negative wire 56 extending between the speakers 26, 28, through the connectors 38, 40 and flexible tubes 30, 32. Referring briefly to FIG. 6, the negative wire 56 is electrically connected to the speaker element 58 within the speaker housing 60 of the speaker 26. The negative wire 56 is likewise connected to the speaker 28 in a manner that is not shown, but is identical to its connection to the speaker 26.

The positive wire 50 is connected to the positive wire 62, which passes through the connector 38, flexible tubing 30, and is electrically connected with the speaker element 58. A complete electrical circuit for the signal to speaker 26 is thereby formed from the cord 44 through the negative wire 54, negative wire 56, speaker element 58, positive wire 62, and positive wire 50.

The positive wire 52 is connected to the positive wire 64, which runs through the connector 40, flexible tubing 32, to the speaker 28, where it is electrically connected within the speaker 28 in the same manner as the wire 62 is electrically connected to the speaker 26. A complete circuit for the signal directed towards the speaker 28 is thereby provided from the cord 44 through the negative wire 54, negative wire 56, the speaker element of the speaker 28, the positive wire 64, and the positive wire 52.

An electrical connector 66 may be provided on the housing 12, and in the illustrated example is a standard female connector 66. The connector 66 includes a positive wire 68 that is electrically connected to the positive wire 62, so that the wire 68 will carry the signal within the wire 50 through the connector 66. Likewise, the positive wire 70 is electrically connected to the positive wire 64, and will therefore carry the signal from the wire 52 through the connector 66. In the same manner, the negative wire 72 is electrically connected to the negative wire 56, and will therefore carry the signal from the negative wire 54 through the connector 66. If the use of more than one speaker system 10 is desired, the male connector 46 may be plugged into the female connector 66, so that the signal's input into the first speaker system 10 through the first cord 44 will then be input into the second speaker system 10. Multiple speaker systems 10 may thereby be connected.

In use, the hook 42 of the speaker system 10 will be used to position the speaker system 10 in a desired location, for example, the back of a chair. The plug 46 will be plugged into a stereo system or other audio source. The flexible tubes 30, 32 will be bent to position the speakers 26, 28 in a desired location, for example, relatively close to the user's ears to facilitate listening to music or other audio material at a low volume. The same speakers may be utilized if a sufficient volume to allow others to listen to the audio material is desired, by merely repositioning the speakers so they are farther from a listener's ears. The speakers 26, 28 will thereby transmit the desired sounds upon actuation of the audio source.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the appended claims and any and all equivalents thereof.

1. A speaker system, comprising:
a housing structured to be removably secured to another object, the housing containing electrical wiring therein;
means for connecting the electrical wiring within the housing to an audio source, the wiring being structured to carry an electrical signal from the audio source to at least one speaker; and
at least one flexibly positionable speaker secured to the housing, the at least one flexibly positionable speaker being electrically connected to the wiring within the housing.

2. The speaker system according to claim 1, wherein the housing is structured to fit over a back of a chair.

3. The speaker system according to claim 2, further comprising at least one hook structured to fit over a back of a chair.

4. The speaker system according to claim 1, wherein the speaker system is structured to permit positioning of the at least one speaker adjacent to a listener's ear when the listener is sitting in the chair.

5. The speaker system according to claim 1, wherein the speaker is secured to the housing by flexible tubing.

6. The speaker system according to claim 5, further comprising a rigid tubular connection disposed between the flexible tubing and the housing.

7. The speaker system according to claim 5:
further comprising means for removably securing the housing to a back of a chair; and
the flexible metal tubing is structured to permit positioning of the at least one speaker adjacent to a listener's ear when the listener is sitting in the chair.

8. The speaker system according to claim 7, further comprising means for interconnecting at least one additional speaker system.

9. The speaker system according to claim 1, further comprising means for interconnecting at least one additional speaker system.
